(19) United States
(12) Patent Application Publication
(10) Pub. No.: US 2004/0145441 A1
(43) Pub. Date: Jul. 29, 2004

(54) Inductor with resistive termination

(76) Inventor: David W. Arnett, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 10/352,710

(22) Filed: Jan. 28, 2003

(51) Int. Cl. H01F 5/00

(52) U.S. Cl. 336/200

(57) ABSTRACT

An inductor with resistive termination, according to one embodiment of the invention, is disclosed that includes an insulating matrix and one or more conductive elements situated within the insulating matrix. The conductive elements provide inductance and include at least one resistive conductive element having a resistance sufficient to provide the resistive termination.

### BACKGROUND

Electronic circuits within many classes of electronic devices continue to increase in complexity and operating speed. As a result of the increased speed, the circuits are becoming more capable of emitting radio-frequency energy that can cause interruptions to radio services. As a result of the increased complexity, electronic devices may be more susceptible to disturbance from strong radio noise sources. Electronic devices are required, by law if not by market forces, to operate properly in an environment with strong radio noise while not creating disruptive radio noise themselves. The ability of an electronic device to operate in this manner is often called electromagnetic compatibility.

High-speed electronic circuits may use series source termination resistors on the conductive traces of circuit boards that form the circuits, near specific electronic components, to improve signal integrity. To improve the electromagnetic compatibility of electronic devices, inductors are may also be added on the conductive traces of circuit boards that form the circuits, near specific electronic components. The inductors serve to block the radio-frequency electromagnetic radiation from entering or leaving the component. However, circuit boards may not necessarily be equipped for inductors, making their placement near the intended circuit components difficult. Furthermore, adding inductors increases the resulting cost of the electronic devices. Although the increase in cost may be measured only in pennies, it can still negatively affect the profitability of the manufacturers and vendors of the devices.

### SUMMARY OF THE INVENTION

An inductor with resistive termination in one embodiment of the invention includes an insulating matrix and one or more conductive elements situated within the insulating matrix. The conductive elements provide inductance and include at least one conductive element having a resistance sufficient to provide resistive termination.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a side-profile of an inductor with resistive termination, according to an embodiment of the invention.

FIG. 2 is a circuit diagram of the inductor of FIG. 1, according to an embodiment of the invention.

FIG. 3 is a diagram of a representative circuit board that includes an inductor with resistive termination, such as the inductor of FIG. 1, according to an embodiment of the invention.

FIG. 4 is a block diagram of a representative electronic device that includes an inductor with resistive termination, such as the inductor of FIG. 1, according to an embodiment of the invention.

FIGS. 5A and 5B are flowcharts of a method for fabricating an inductor with resistive termination, according to an embodiment of the invention, such as the inductor of FIG. 1.

FIG. 6 is a flowchart of a method for using an inductor with resistive termination, such as the inductor of FIG. 1, within a circuit board or an electronic device, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Overview

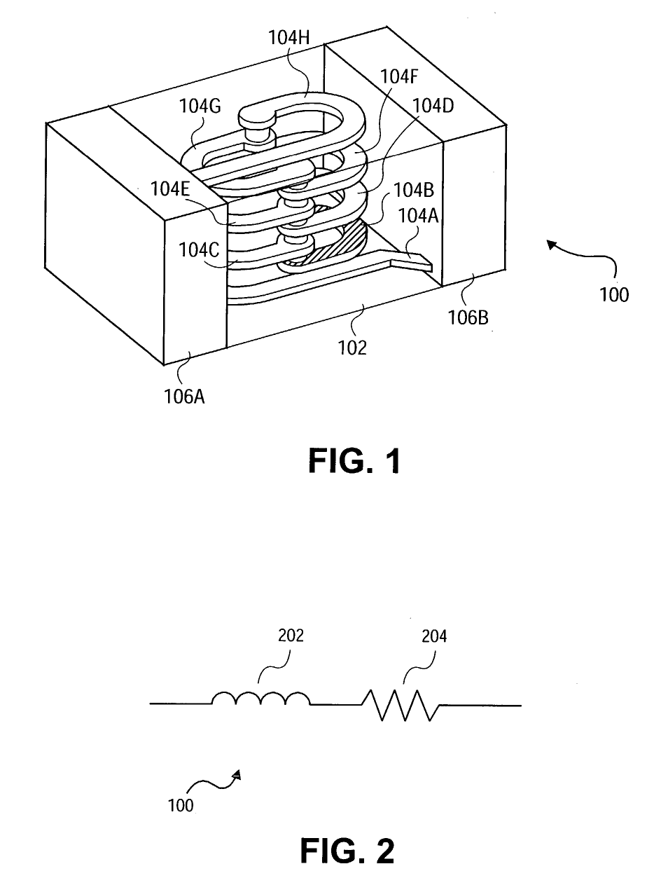

FIG. 1 shows an inductor with resistive termination 100, according to an embodiment of the invention. The inductor 100 has an insulating matrix 102 and a number of conductive elements 104A, 104B, 104C, 104D, 104E, 104F, 104G, and 104H, collectively referred to as the conductive elements 104, between a pair of external electrodes 106A and 106B, collectively referred to as the external electrodes 106. The insulating matrix 102 may also be referred to as a dielectric matrix. It is at least substantially an electrical insulator, and can in one embodiment be made of insulating ceramic. The insulating matrix 102 can in one embodiment be a ferrite matrix. Ferrite is a class of ceramic insulating material that has lossy magnetic properties. The ferrite material may have a characteristic such that an impedance resulting therefrom is primarily resistive over a frequency range. Alternatively, the ferrite material may have a characteristic such that an impedance resulting therefrom is primarily inductive over a frequency range.

The conductive elements 104 are inductive such that they substantially block high-frequency electromagnetic radiation. Adjacent of the conductive elements 104 are electrically connected to one another. For example, the conductive element 104A is electrically connected to the conductive element 104B, the conductive element 104B to the conductive element 104C, and so on.

The conductive elements 104 effectively act as a coil. That is, as depicted in FIG. 1, current running through the conductive element 104A must pass from right to left before it contacts the conductive element 104B. The current must then pass through the conductive element 104B from left to right before it contacts the conductive element 104C. The insulating matrix 102 thus partially separates the conductive elements 104, such that adjacent of the conductive elements 104 are electrically connected at one or more points.

As also depicted in FIG. 1, the conductive elements 104 are preferably horseshoe-shaped conductive ferrite inductors, each with a downward extension to contact an adjacent conductive element below. The conductive element 104A also has one leg extending such that it makes contact with the electrode 106B. Similarly, the conductive element 104H has one leg extending such that it makes contact with the electrode 106A.

The conductive elements 104 in FIG. 1, except for the shaded conductive element 104B, have a relatively low resistance, and thus are good conductors. The shaded conductive element 104B is also a good conductor, but has a greater resistance than the other of the conductive elements 104, and thus can be said to have a medium resistance. The resistance of the conductive element 104B is medium in that it is greater than the low resistance of the other of the conductive elements 104, but is not high enough to be an insulator. That is, the conductive element 104B is still a conductor. The resistance of the conductive element 104B is sufficient to provide the resistive termination functionality of the inductor 100. That is, the conductive element 104B has a sufficiently great resistance that the inductor 100 also acts as a resistor, in addition to acting as an inductor.

In alternative embodiments, other of the conductive elements 104, in lieu of or in addition to the conductive element 104B, may have greater resistances like that of the conductive element 104B. For instance, all of the conductive elements 104 may have greater resistances to provide resistive termination, or only one or a subset of the conductive elements 104 may have such greater resistances. This can depend on the resistance of the inductor 100 that is desired.

FIG. 2 shows the inductor 100 modeled as a circuit diagram, according to an embodiment of the invention. The inductor 100 includes an inductive element 202 and a resistive element 204. The inductive element 202 is provided by the conductive elements 104 of FIG. 1. The resistive element 204 is substantially provided by those of the conductive elements 104 that have greater resistance, such as the conductive element 104B in FIG. 1. Thus, the inductor 100 has both inductive and resistive functionality. The inductive functionality can be likened to high-frequency current blocking functionality, whereas the resistive functionality can be likened to low-frequency impedance matching functionality.

Circuit Board and Electronic Device

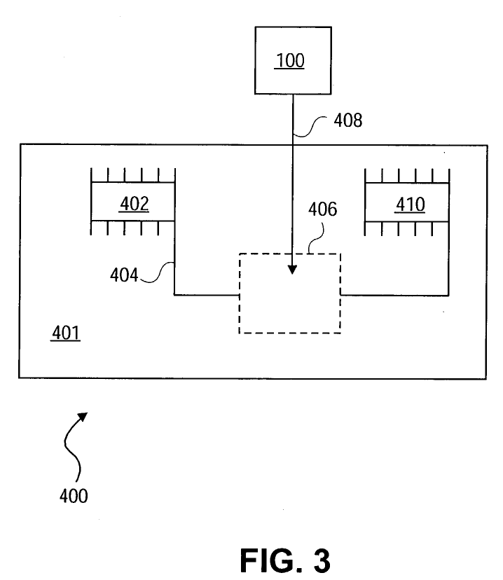

FIG. 3 shows a representative circuit board 400, according to an embodiment of the invention. The circuit board 400 includes a substrate 401 on which electrical components can be mounted. The circuit board 400 is depicted in FIG. 3 as including two electrical components 402 and 410, such as integrated circuits (IC's), but there may be and typically are more than two electrical components, as can be appreciated by those of ordinary skill within the art. Similarly, the circuit 400 is depicted in FIG. 3 as including one conductive trace 404 extending from a pin of the component 402 to a pin of the component 410, but there may be and typically is more than one conductive trace, as can be appreciated by those of ordinary skill within the art.

The circuit board 400 has a predetermined location 406 on the conductive trace 404 that is originally intended for a resistive termination-only device. For instance, the predetermined location 406 on the circuit board 400 may be intended for a surface-mount resistor, to provide resistive termination for the electrical component 402. However, as depicted in FIG. 3, the predetermined location 406 is instead utilized by the inductor 100, as indicated by the arrow 408. Thus, a circuit designer does not have to find another location for an inductor without resistive termination where the predetermined location 406 is utilized for a resistive termination-only device. Rather, the inductor 100, which provides both inductive high-frequency blocking and resistive low-frequency matching functionality, can be located on the predetermined location 406. It is stated that the inductor 100 interrupts the conductive trace 404, because it is inserted in-line and in-series with the conductive trace 404. Thus, the predetermined location 406 interrupts the conductive trace 404, such that the inductor occupies this location 406.

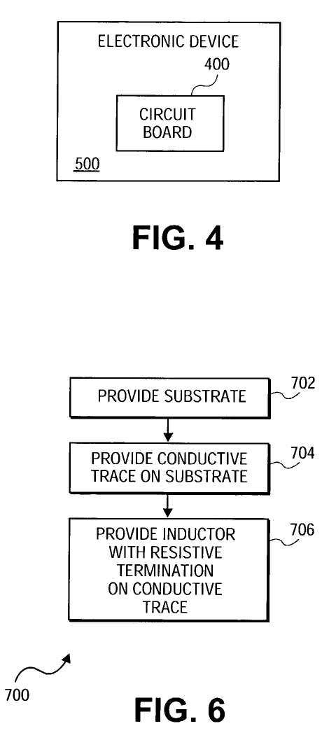

FIG. 4 shows a representative electronic device 500, according to an embodiment of the invention. The electronic device 500 is not limited by embodiments of the invention and can be, for instance, an image-forming device, such as an inkjet or a laser printer, or another type of electronic device. Particularly, the electronic device 500 includes the circuit board 400 of FIG. 3. Thus, the electronic device 500 includes an inductor with resistive termination capability, such as the inductor 100 of FIG. 1 that has been described.

Methods of Manufacture and of Use

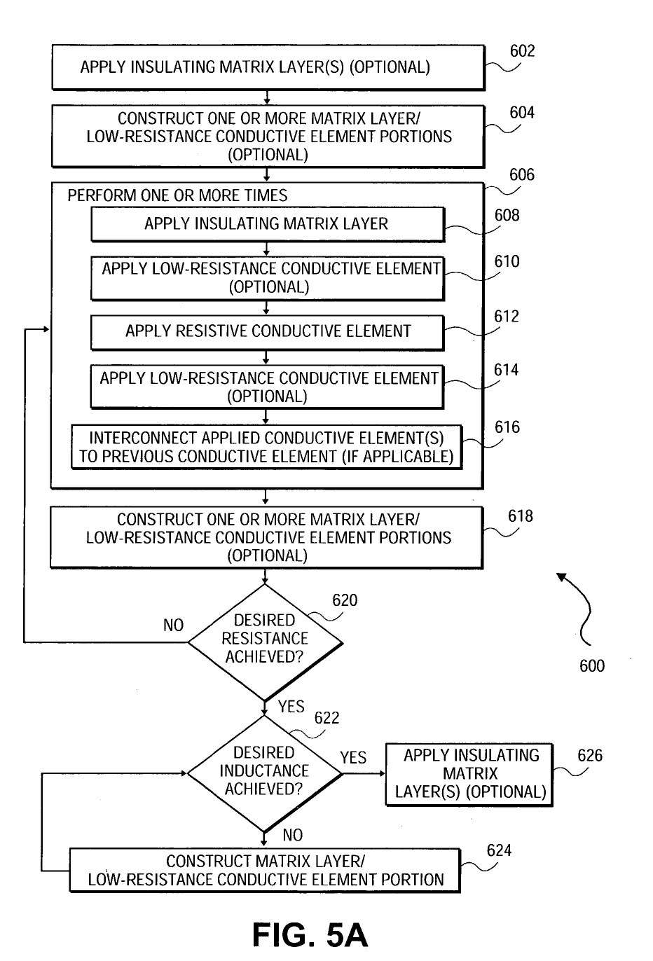

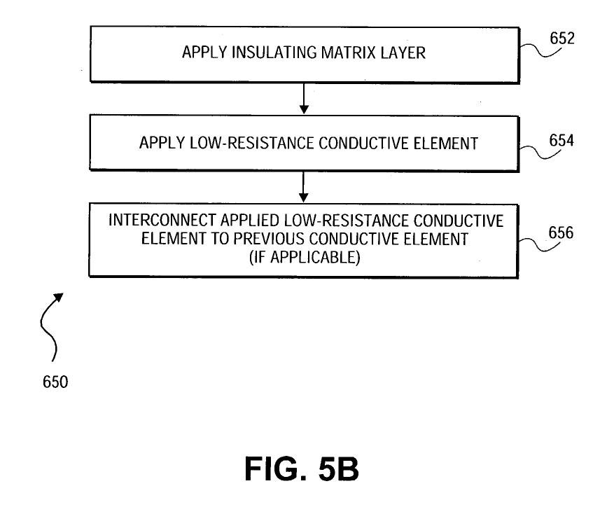

FIG. 5A shows a method 600 for manufacturing an inductor with resistive termination, such as the inductor 100 of FIG. 1, according to an embodiment of the invention. The insulating matrix 102 of the inductor 100 is specifically manufactured by applying insulating matrix layers, the collection of which makes up the insulating matrix 102. That is, the insulating matrix 102 of the inductor 100 is made up of a number of insulating matrix layers, as will be described. The insulating matrix layers may be insulating ceramic layers, for instance. Therefore, first, one or more initial insulating matrix layer(s) are optionally applied (602). Such insulating matrix layer(s) are applied if a bottom insulating portion of the inductor being fabricated is desired. Further, one or more insulating matrix layer/low-resistance conductive element portions are optionally constructed (604), as is more particularly described with reference to FIG. 5B, later in the detailed description. Such portions are constructed if low-resistance element portions are desired to be included in the inductor's bottom layers prior to adding the resistive conductive elements.

Next, the method 600 performs 606 a desired number of times. This entails first applying an insulating matrix layer (608), and optionally a low-resistance conductive element (610). A resistive conductive element is then applied (612), followed optionally by another low-resistance conductive element (614). The resistive conductive element provided in 612, along with any other resistive conductive elements that have been or will be applied, provide the desired resistance of the inductor being fabricated. The low-resistance conductive elements optionally applied before and after the resistive conductive element is applied in 612 may be applied to surround the resistive conductive element with low-resistance conductive elements. Finally, if there are previously applied conductive element(s) to the most recently applied conductive element(s) in 610, 612, and 614, then the most recently applied conductive element(s) are interconnected to them (616).

One or more insulating matrix layer/low-resistance conductive element portions are then optionally constructed (618), as is more particularly described with reference to FIG. 5B, later in the detailed description. Such portions are constructed here if further low-resistance element portions are desired to be included between applications of the resistive conductive elements in 606. If the desired resistance, owing, at least substantially, to the resistive conductive elements that have been applied in 606, has not yet been achieved (620), then the method 600 repeats at 606. Otherwise, if the desired resistance has been achieved (620), then the method 600 determines whether the desired inductance of the inductor has been achieved (622). If not, then a matrix layer/low-resistance conductive element portion is constructed (624), as is more particularly described with reference to FIG. 5B, later in the detailed description, and the method 600 again determines whether the desired inductance has been achieved (622). Once the desired inductance has been achieved, one or more final insulating matrix layer(s) are optionally applied (626).

Where a low-resistance conductive element and a resistive conductive element, such as a medium-resistance conductive element as has been described, are desired for inclusion on the same layer, the elements may be printed on the insulating matrix layer using a screen-printing process employing conductive metal-filled inks. The low-resistance conductor may be used to form the conductive element in the vicinity of an interconnect hole. However, the entire conductive element need not be made utilizing low-resistance ink. Rather, a complete, or nearly complete, conductive element may be printed using a medium-resistance material, with an overprint of a low-resistance material in the areas of the element near where interconnection is to occur.

FIG. 5B shows a method 650 for constructing the matrix layer/low-resistance conductive element portion as performed in 604, 618, and 624 of the method 600 of FIG. 5A, according to an embodiment of the invention. First, an insulating matrix layer, such as an insulating ceramic matrix layer, is applied (652). Next, a low-resistance conductive element is applied (654). If there exists a previously applied conductive element, then the low-resistance conductive element just applied in 654 is interconnected with this previous conductive element (656).

FIG. 6 shows a method 700 for using an inductor with resistive termination, such as the circuit board 400 of FIG. 3, according to an embodiment of the invention. The substrate of the circuit board is initially provided (702), and at least one conductive trace is provided on the substrate (704). As can be appreciated by those of ordinary skill within the art, one or more electrical components may also be provided. An inductor with resistive termination, such as the inductor 100 of FIG. 1, is then provided on the conductive trace (706), such that the inductor interrupts the conductive trace. The inductor thus functions to block high-frequency currents that are otherwise present on the conductive trace, while permitting proper signaling in the circuit. The result is better electromagnetic compatibility.

Conclusion

An inductor with resistive termination has been described. The inductor may include an insulating matrix with a ferrite material, and one or more conductive elements situated within the insulating matrix. The conductive elements include at least one resistive conductive element having a resistance sufficient to provide the resistive termination. As has been described, the ferrite material may have a characteristic such that an impedance resulting therefrom is primarily resistive over a frequency range, or is primarily inductive over a frequency range.

In another embodiment, the inductor with resistive termination includes an insulating matrix and one or more elements situated within the insulating matrix to provide both high-frequency current blocking and low-frequency impedance matching functionality, as have been described. The elements together provide the high-frequency current blocking functionality, and at least one conductive element having a resistance greater than that of a low-resistance conductive element provides low-frequency impedance matching functionality.

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of the disclosed embodiments of the present invention. Therefore, it is manifestly intended that this invention be limited only by the claims and equivalents thereof.

I claim:

1. A component with resistive termination comprising:
an insulating matrix including a ferrite material; and,
at least one conductive element situated within the insulating matrix, the at least one conductive element including a resistive conductive element having a resistance sufficient to provide the resistive termination.

2. The component of claim 1, wherein the ferrite material has a characteristic such that an impedance resulting from the ferrite material is primarily resistive over a frequency range.

3. The component of claim 1, wherein the ferrite material has a characteristic such that an impedance resulting from the ferrite material is primarily inductive over a frequency range.

4. An inductor with resistive termination comprising:
an insulating matrix; and,
one or more conductive elements situated within the insulating matrix, the one or more conductive elements providing inductance and including at least one resistive conductive element having a resistance sufficient to provide the resistive termination.

5. The inductor of claim 4, wherein the insulating matrix comprises an insulating ceramic matrix.

6. The inductor of claim 5, wherein the insulating ceramic matrix comprises a ferrite matrix.

7. The inductor of claim 4, wherein the one or more conductive elements further include one or more low-resistance conductive elements, the resistance of the at least one resistive conductive element sufficient to provide the resistive termination greater than a resistance of the one or more low-resistance conductive elements.

8. The inductor of claim 4, wherein the one or more conductive elements comprise a plurality of horseshoe-shaped elements.

9. An inductor with resistive termination comprising:
an insulating matrix; and,
one or more elements situated within the insulating matrix to provide both high-frequency current blocking and low-frequency impedance matching functionality.

10. The inductor of claim 9, wherein the insulating matrix comprises an insulating ceramic matrix.

11. The inductor of claim 10, wherein the insulating ceramic matrix comprises a ferrite matrix.

12. The inductor of claim 9, wherein the one or more elements comprise a plurality of conductive elements, including a conductive element having a resistance sufficient to provide resistive termination.

13. The inductor of claim 9, wherein the one or more elements comprise one or more low-resistance conductive elements to provide the high-frequency current blocking functionality, and at least one conductive element having a resistance greater than that of the one or more low-resistance conductive elements to provide at least the low-frequency impedance matching functionality.

14. The inductor of claim 9, wherein the one or more elements comprise a plurality of horseshoe-shaped elements.

15. An inductor with resistive termination comprising:
an insulating matrix; and,
means for providing inductance and resistance termination, situated within the insulating matrix.

16. The inductor of claim 15, wherein the insulating matrix comprises an insulating ceramic matrix.

17. The inductor of claim 16, wherein the insulating ceramic matrix comprises a ferrite matrix.

18. The inductor of claim 15, wherein the means comprises one or more conductive elements, including at least one conductive element having a resistance sufficient to provide the resistance termination.

19. An inductor comprising:
an insulating matrix; and,
means for high-frequency current blocking and low-frequency impedance matching, situated within the insulating matrix.

20. The inductor of claim 19, wherein the means comprises one or more conductive elements, including at least one conductive element having a resistance sufficient to provide impedance matching at low frequencies.

21. The inductor of claim 19, wherein the insulating matrix comprises an insulating ceramic matrix.

22. The inductor of claim 21, wherein the insulating ceramic matrix comprises a ferrite matrix.

23. A circuit board comprising:
a substrate;
a conductive trace on the substrate; and,
an inductor with resistive termination interrupting the conductive trace.

24. The circuit board of claim 23, further comprising an electrical component positioned at an end of the conductive trace.

25. The circuit board of claim 23, further comprising a predetermined location interrupting the conductive trace, originally intended for a resistive termination-only device, on which the inductor with the resistive termination is located.

26. The circuit board of claim 23, wherein the inductor with the resistive termination comprises:
an insulating matrix; and,
a plurality of conductive elements within the insulating matrix and including at least one conductive element having a resistance sufficient to provide the resistive termination.

27. The circuit board of claim 26, wherein the insulating matrix includes a ferrite matrix.

28. The circuit board of claim 26, wherein the plurality of conductive elements includes a plurality of horseshoe-shaped elements.

29. An electronic device comprising:
a circuit board;
a conductive trace on the circuit board; and,
an inductor with resistive termination interrupting the conductive trace.

30. The electronic device of claim 29, further comprising an electrical component positioned at an end of the conductive trace.

31. The electronic device of claim 29, further comprising a predetermined location interrupting the conductive trace originally intended for a resistive termination-only device on which the inductor with resistive termination is located.

32. The electronic device of claim 29, wherein the inductor with resistive termination comprises:
an insulating matrix; and,
a plurality of conductive elements within the insulating matrix and including at least one conductive element having a resistance sufficient to provide the resistive termination.

33. A method for manufacturing an inductor with resistive termination comprising:
repeating
applying an insulating matrix layer;
applying a resistive conductive element;
interconnecting the resistive conductive element to the immediate prior conductive element as applicable,
until a desired resistance of the inductor is achieved;
where a desired inductance of the inductor remains unachieved,
repeating
applying a second insulating matrix layer;
applying a low-resistance conductive element; and,
interconnecting the low-resistance conductive element to the immediate prior conductive element,
until the desired inductance of the inductor is achieved.

34. The method of claim 33, further initially comprising applying one or more initial insulating matrix layers.

35. The method of claim 33, further initially comprising performing one or more times:
applying an initial insulating matrix layer;
applying a low-resistance conductive element; and,
interconnecting the low-resistance conductive element to the immediate prior conductive element as applicable.

36. The method of claim 33, further comprising, prior to applying the resistive conductive element, applying a second low-resistance conductive element.

37. The method of claim 33, further comprising, after applying the resistive conductive element, applying a second low-resistance conductive element.

38. The method of claim 33, further comprising, once the desired inductance of the inductor has been achieved, applying one or more final insulating matrix layers.

39. The method of claim 33, wherein applying the insulating matrix layer and applying the second insulating matrix layer each comprises applying an insulating ceramic matrix layer.

40. The method of claim 39, wherein applying the insulating ceramic matrix layer comprises applying an insulating ceramic ferrite matrix layer.

41. A method comprising:
providing a substrate;
providing a conductive trace on the substrate; and,
providing an inductor with resistive termination on the conductive trace, the inductor interrupting the conductive trace.

42. The method of claim 41, wherein providing the substrate comprises providing a circuit board.

43. The method of claim 41, wherein providing the inductor with resistive termination comprises providing an inductor having an insulating matrix within which a plurality of conductive elements are situated, at least one of the plurality of conductive elements having a resistance sufficient to provide the resistive termination of the inductor.
